(19) United States
(12) Patent Application Publication
(10) Pub. No.: US 2003/0150794 A1
(43) Pub. Date: Aug. 14, 2003

(54) Discoid filtration body

(76) Inventors: Dieter Blase, Mutlangen (DE); Hans Olapinski, Aichwald (DE); Hans-Peter Feuerpeil, Schwabisch Gmund (DE)

Correspondence Address: Charles N J Ruggiero, Ohlandt Greeley Ruggiero & Perle, 10th Floor, One Landmark Square, Stamford, CT, 06901-2682, US

(21) Appl. No.: 10/276,010

(22) PCT Filed: May 7, 2001
(86) PCT No.: PCT/EP01/05145

(30) Foreign Application Priority Data
May 12, 2000 (DE) 100-23-292.2

(51) Int. Cl. B01D 29/01

(52) U.S. Cl. 210/498; 264/299

(57) ABSTRACT

The invention relates to a method for the production of a discoid filtration body (filter plate), comprising two internally connected support bodies, made from porous material and which enclose filtrate drain channels between them and at least one membrane filter layer on the external side of the support body halves. The invention is characterised by the following method steps: both support body halves (3.2, 3.3) are produced by casting after the slip casting method; the casting mould (10) comprises a porous, optionally hydrophilic material; the mould cavity is shaped such that the inner contour thereof closely corresponds to the external contour of the support body (3.2, 3.3); for the production of both connected support body halves (3.2, 3.3), a first amount of suspended support body material, corresponding to a support body half (3.2), is poured into the mould; an intermediate body (3.7), functioning as mould core with recesses and made from a material which is volatile to heat treatment is applied to the first amount of suspended support body material; a second amount of suspended support body material, which corresponds to the second support body half (3.3), is poured into the mould (10.1); the surface of said second casting is optionally brought in to contact with a cover (10.2) for the mould; the complete moulded piece comprising the both connected support body halves (3.2, 3.3) and the intermediate body is taken from the mould (10), sintered and, optionally, worked; and at least one filtering layer (3.5) is mounted on the outer surface of the moulded piece.

The present invention relates to a method for producing a plate-shaped filtration body—referred to in the following as a “filtration plate”—and to such a filtration plate itself.

Reference is made to German Patent 100 19 672 and German Patent 100 23 292. Such filtration plates are described and shown therein.

Such filtration plates may, for example, have the shape of a circular disk. They are made, for example, of a filter membrane material, for example of porous silicon dioxide. A device for filtering free-flowing media may include multiple such filtration plates. The filtration plates are arranged coaxially to one another in this case and have a mutual distance to one another. A hollow shaft is guided through all of the filtration plates. The individual filtration plates have permeate diversion channels inside them, which have a conductive connection to the inside of the hollow shaft.

Special requirements are placed on filtration plates of the type described. These particularly relate to the strength of the individual plates. Thus, the filtration plates are to stand up to the significant strains as a consequence of currents in a filtration facility during operation. The individual plates are, however, also to be sufficiently strong per se that, for example, in a construction of multiple layers, the bond between such layers is permanent. The plates are to be easily to assemble into plate assemblies of the construction described. They are to be easily producible and cost-effective. They are to be easy to handle, which affects mounting and demounting.

The previously known filtration plates have not completely and sufficiently fulfilled these requirements.

The present invention is based on the object of designing filtration plates in such a way that they fulfill the requirements described to a higher degree than the previously known filtration plates.

This object is achieved by the independent claims.

The inventors have found new ways for achieving this object. According to a first achievement of the object, they suggest producing the filtration plates through casting, on the basis of the slip casting method.

According to a second achievement of the object, the filtration plates are produced from sinterable material, which is compressed and sintered.

The present invention is described in more detail with reference to the drawing. The following is shown in detail therein:

FIG. 1 shows a device having filter plates according to the present invention in a schematic outline view.

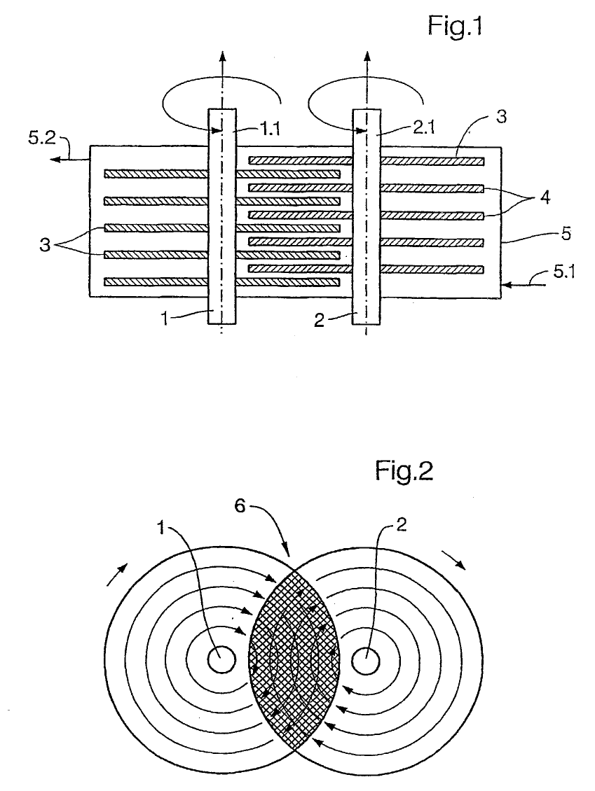

FIG. 2 shows the object of FIG. 1 in a top view.

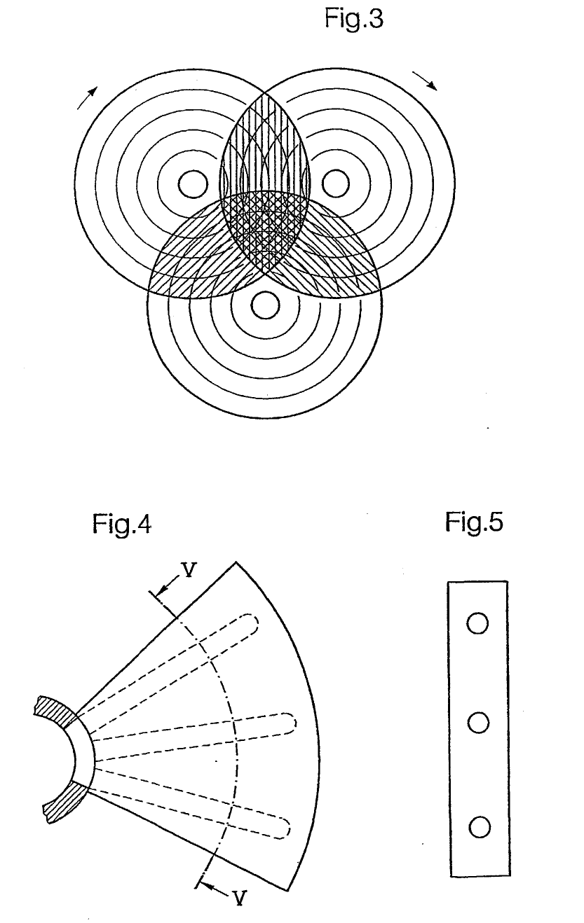

FIG. 3 shows an altered embodiment of the object of FIG. 1, again in a top view.

FIG. 4 shows a segment as a component of the filtration plate in a top view.

FIG. 5 shows a sectional view along section line V-V of FIG. 4 in an unwound view.

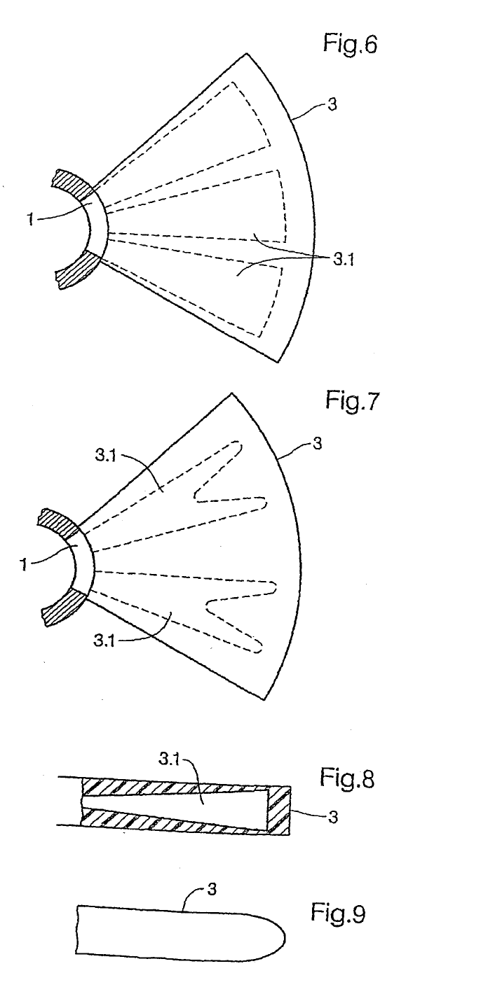

FIGS. 6 and 7 show two further embodiments of segments in a top view.

FIG. 8 illustrates an axial section of a filtration plate having a specific channel configuration.

FIG. 9 shows a filtration plate in a side view.

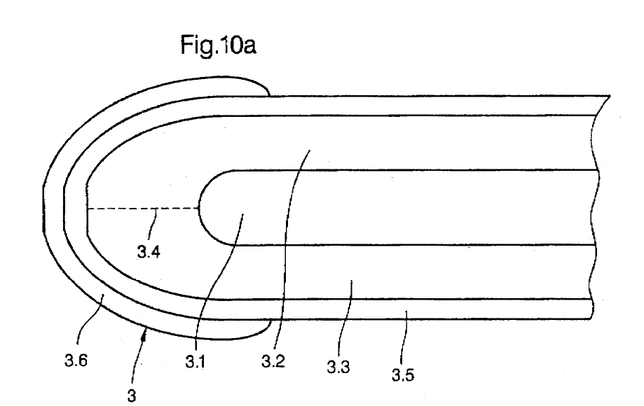

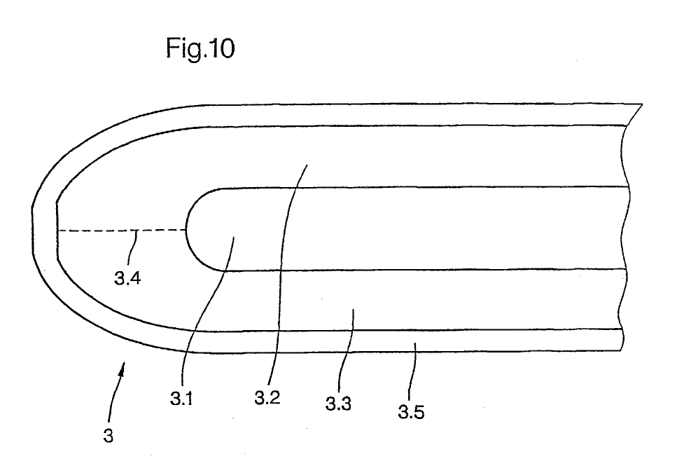

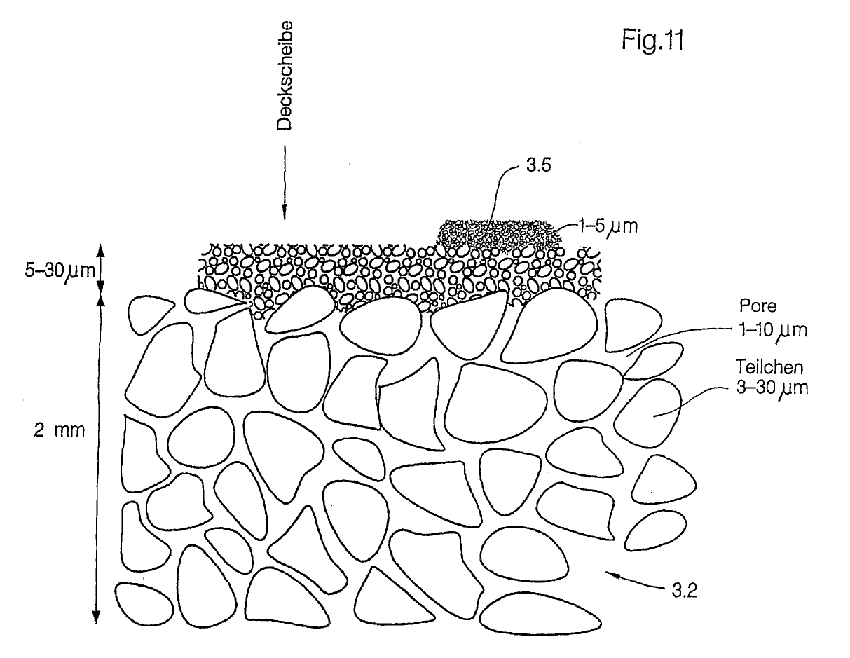

FIG. 10 shows, in a section perpendicular to the plate plane—i.e., parallel to the rotational axis of hollow shafts 1, 2—the construction of a filtration plate according to the present invention.

FIG. 10a shows, in a section perpendicular to the plate plane—analogously to FIG. 10—the construction of a filtration plate according to the present invention in an altered embodiment.

FIG. 11 shows, in greatly enlarged scale, the structure of a support body and the structure of a membrane filter layer.

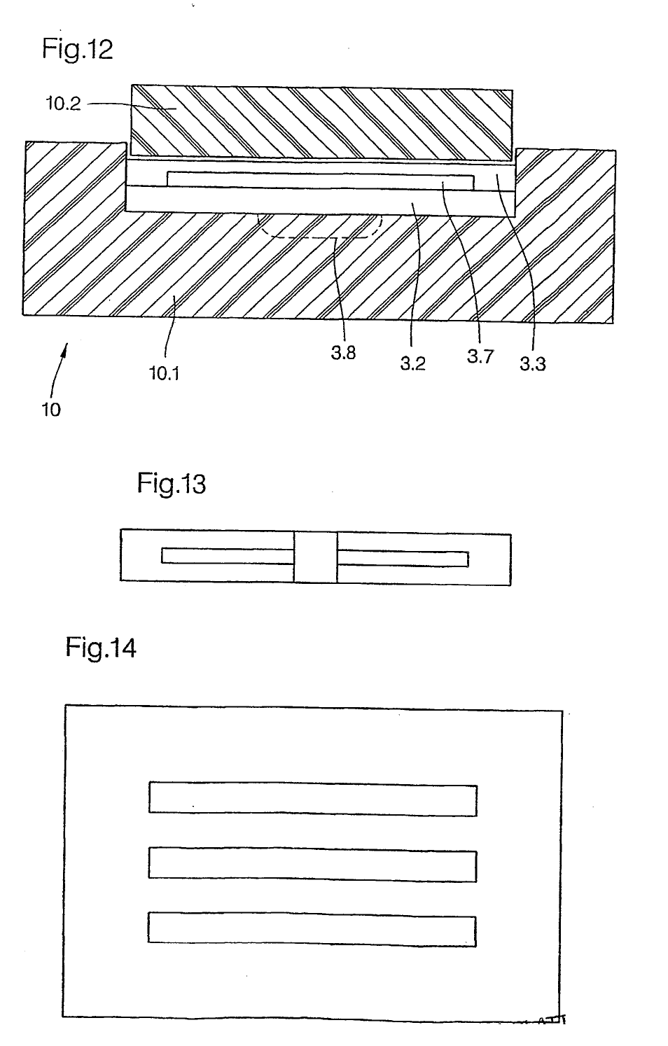

FIGS. 12, 13, and 14 illustrate the sequence of the method for producing a filtration plate according to the present invention according to the first achievement of the object.

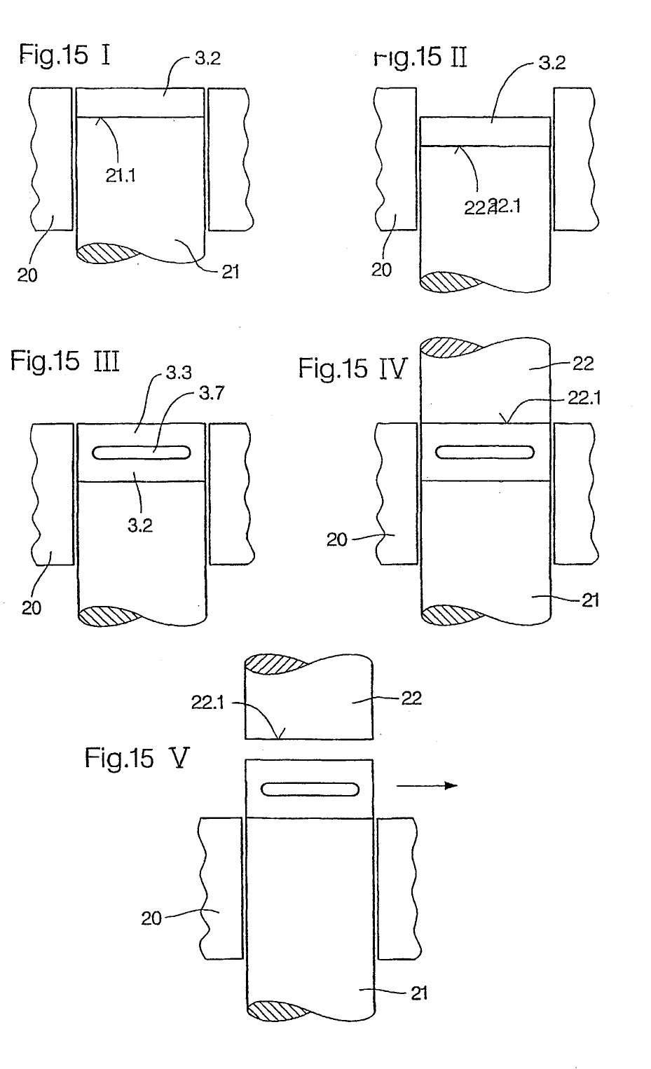

FIG. 15 schematically shows a part of a device for performing the second achievement of the object and illustrates its individual phases.

As may be seen in FIG. 1, the device has two hollow shafts 1, 2. Each of the two hollow shafts is assigned a plate assembly 3 and 4, respectively. The filtration plates are positioned parallel to one another. Filtration plates 3 are connected to hollow shaft 1, and filtration plates 4 to hollow shaft 2, so that they rotate together.

Filtration plates 3, 4 comprise porous ceramic material having a ceramic membrane, which forms the external filtration plate surface. As may be seen in FIGS. 4 and 5, they are provided with channels. Since FIGS. 4 and 5 relate to a segment of filtration plates 3, channels 3.1 may be seen therein. The channels are positioned radially. They therefore run from the periphery of the segment to hollow shaft 3 and have a conductive connection to the inside of the hollow shaft. Certain deviations from the radial direction are possible.

Instead of the embodiment illustrated, the following variant is also conceivable: Two or more assemblies are provided. At least one of them has a hollow shaft and supports active filtration plates. A number of assemblies may also be equipped with dummy plates, with or without a hollow shaft.

The hollow shaft described and the assigned filtration plates are referred to as an “assembly” here. In this case, the assembly formed by hollow shaft 1 and filtration plates 3 is designed and constructed identically to the packet constructed from hollow shaft 2 and filtration plates 4. However, deviations from this would also be possible. Thus, for example, the filtration plates of one assembly may have a larger diameter than the filtration plates of the other assembly. In the present case, the filtration plates are circular. Deviations would also be possible here. For example, an oval shape could be considered.

The two assemblies are positioned in a container 5. Container 5 has an inlet 5.1 and an outlet 5.2. Both hollow shafts 1, 2 have outlets 1.1 and 1.2, respectively, at their upper end.

The device operates as follows:

The medium to be treated is supplied to the container through inlet 5.1. The filtrate/permeate reaches channels 3.1 or 4.1, respectively, (the latter not shown here) through the pores of the ceramic material of the ceramic disks. The permeate reaches the inside of both hollow shafts 1, 2 from the channels and is drained off at outlets 1.1, 1.2.

What is not able to penetrate to the pores of the ceramic material reaches outlet 5.2 of container 5 as the retentate.

As may be seen in the illustration of FIG. 2, filtration plates 3 of one assembly overlap with filtration plates 4 of the other assembly. A turbulence arises in the medium in overlap region 6. This results in a cleaning effect on the surface of the filtration plates. The specific permeation performance is large and the specific power consumption is small.

In the embodiment shown in FIG. 3, three assemblies are provided. They are again positioned in a container—not shown here.

A further possibility is to provide an even greater number of assemblies inside one single device. Thus, for example, one assembly may be positioned centrally, while the remaining assemblies are grouped concentrically around the central assembly.

As is shown in FIGS. 4 and 5, individual filtration plates 3, 4 may be constructed from multiple segments. The circular segment illustrated here is therefore a component of a filtration plate 3. However, the filtration plates may also be constructed completely from one single part.

Filtration plates 3 illustrated in FIGS. 5 and 6 have permeate channels 3.1 of specific configurations. As is shown, the channels taper from the outside to the inside, seen in this top view. They are therefore wedge-shaped.

In the embodiment shown in FIG. 7, channels 3.1 are again wedge-shaped, but they each have an indentation in the radial external region. The channels therefore have a type of forked branch shape in this top view.

The intention of this channel design is that the permeate has to cover a shorter path to the permeate diversion channel in this way.

Another effect is achieved by the channel design shown in FIG. 8-viewed in an axial section through the plate assembly in this case. As is shown, the channel again tapers from the outside to the inside. The intention is as follows: for a rotating filtration plate, the permeate in the outer region of the filtration plate is under a slightly elevated pressure. The design of the channel shown compensates this elevated pressure through the reduced wall thickness. The channels may finally be designed in such a way that the flow speed of the filtrate/permeate on its path toward the hollow shaft is constant.

It may be seen in FIG. 9 that the periphery of filtration plate 3 is designed to have a streamlined shape, like the edges of a hydrofoil which liquid flows against. It has been shown that the wear of the membrane is significantly minimized in this way.

Filtration plate 3 illustrated in FIG. 10 is constructed as follows: it includes two support body halves 3.2, 3.3. These are joined along a plane 3.4. They practically form one single part, so that plane 3.4 has no significance in regard to strength. The significance of plane 3.4 is explained in more detail below.

Permeate channels 3.1 already described, which conduct the permeate to the inside of assigned hollow shaft 1, are located between both support body halves 3.2, 3.3.

Both support body halves 3.2, 3.3 are at least partially coated on their outsides using a membrane filter layer 3.5.

A wear protection may be applied at specific points. It may comprise a separate material. However, the membrane layer thickness may be particularly large at specific points. Furthermore, selective sintering is conceivable, for example using a laser beam.

FIG. 10a shows an interesting variant of a filtration plate according to the present invention. Both support body halves 3.2 and 3.3 may again be seen here. A permeate channel 3.1 is located inside. Plane 3.4 is also recognizable again.

Both of the support bodies are coated on their outer surfaces using a membrane filter layer 3.5. A second membrane filter layer 3.6 is applied in the periphery. This is used above all as a wear protector. For this purpose, however, other materials may also be applied.

FIG. 11 shows the microstructures of a support body half 3.2 and a membrane filter layer 3.5 more precisely. In this case, the support body layer is constructed from particles having a particle size of 3 to 30μ. The pores located between them are of a magnitude from 1 to 10μ. In the present case, support body half 3.2 has a thickness of a few millimeters, for example 2 mm. In contrast, the membrane filter layer is comparatively thin. Its thickness is approximately 5 to 30μ, for example 20μ.

FIGS. 12 and 13 illustrate a method according to the first achievement of the object using the slip casting principle.

FIG. 12 shows a mold 10 for producing a molded part, including both support body halves 3.2, 3.3 and a layer located between them, whose significance will be explained in more detail below. Mold 10 has a bottom part 10.1 and a cover 10.2.

Mold 10 is made of porous, hydrophilic material, for example gypsum. It has a significant wall thickness, which may be many times the thickness of the entire molded part.

The mold cavity is dimension in such a way that it approximately corresponds to the final external contour of the support body, so that the fired disk must be only minimally reprocessed on the external contours, for example through grinding, to achieve the exact final geometry (tolerance).

The method for producing the molded part runs as follows: first, with cover 10.2 removed, one of the two support body halves is poured into mold bottom part 10.1 in the form of a suspension. Due to the hydrophilic character of the material of mold part 10.1, water—or another suspension liquid—is drawn out of the suspension of support body half 3.2 to be formed.

A body 3.7 is then laid on the cast surface of resulting support body half 3.2. This body comprises a material which evaporates in heat. Materials such as wax, camphor, nonwoven material, sponge rubber, etc. come into consideration.

This intermediate body 3.7 is generally relatively thin, for example 2 mm. It is provided with openings, which will be explained in more detail.

After intermediate body 3.7 is placed, a second pouring is performed. The support body material necessary for forming second support body half 3.3 is again poured into mold bottom part 10.1—again in the form of a suspension—so that it lies on intermediate layer 3.7. A tight bond thus results between the two support body materials, in any case in the peripheral region of both support body halves 3.2, 3.3, but also where the openings described lie in support body 3.7. The openings lead to the formation of webs and therefore in turn to a tight bond between both support body halves 3.2, 3.3, so that a uniform, solid body is formed from these two bodies.

Due to the property of the material of intermediate layer 3.7 of evaporating under heat, the material dissolves, so that cavities arise, which form permeate diversion channels 3.1—see FIGS. 4 to 8 and 10.

After the pouring of the material for second support body half 3.1, it must be ensured that, in accordance with the rules of the slip casting method, water is again drawn out of the suspension poured in. This may be performed either via the lower support body half in the direction of mold bottom part 10.1 or via cover 10.2 of mold 10.

Cover 10.2 may be applied after completing the second pouring. However, it is also conceivable to join cover 10.2 with mold bottom part 10.1 from the beginning and leave an appropriate interval for introducing the appropriate pour quantities at the same time; the pour quantities would be supplied in such a case through suitable openings of the mold cavity. In any case, a contact must be produced between the inner surface of cover 10.2 and the surface of the second pouring.

A particularly interesting variant is as follows: mold 10—including mold bottom part 10.1 and cover 10.2—is made of porous material, which does not or does not necessarily have to have hydrophilic character. Intermediate body 3.7 is positioned in the mold cavity at the correct location. Suspension is injected into the mold cavity through an appropriate opening, expediently under a certain pressure. In this case, it fills up the mold cavity and envelops intermediate body 3.7, so that the body is completely embedded in the suspension.

The suspension may now be dehydrated, either through pressure, which is applied from above, for example through pressure which acts through the injection opening, or through other openings. The dehydration may, however, also be carried out in that a partial vacuum acts through the mold on the suspension and liquid is thus suctioned off through the pores of the mold.

An alternative comprises the following:

As in the exemplary embodiment described above, the intermediate body is positioned in the mold cavity. The suspension is then introduced into the mold cavity. The binding agent contained in the suspension is selected in a very specific way, so that a polymerization process occurs. The cast part—both support body halves 3.2, 3.3 in FIG. 12—therefore solidifies. The dehydration, with all its disadvantages, is thus avoided. For this latter method, the mold does not necessarily have to be made of porous material, but may have closed surfaces.

The mold cavity may also be designed in such a way that at least one of both support body halves 3.2, 3.3 is cast in one piece with a hub. See the contour of a corresponding recess 3.8 of the mold cavity.

FIG. 13 shows the molded part removed from the mold. A hole may be provided in its center. This hole may be dimensioned so that assigned hollow shaft 1 may be guided through it. However, it is also sufficient to provide a smaller hole, which is brought to the desired dimension at a later time.

FIG. 14 illustrates an example of the procedure for applying a ceramic membrane filter layer to the ceramic disk according to the dip coating method. For this purpose, multiple mold parts are positioned parallel and coaxial to one another and introduced into an immersion bath having the corresponding membrane filter material. The membrane filter layer is subsequently dried and sintered. However, other methods for applying the membrane are also possible.

FIG. 15 shows an essential part of a device for performing the second achievement of the object. A piston 21, having a face 21.1, may be seen. Furthermore, a cylindrical sleeve 20 may be seen, in which piston 21 is guided.

For performing the method, in a first phase I, sinterable material is applied to face 21.1 of piston 21, so that a filling 3.2 results, which later represents one of the two support body halves.

In phase II, piston 21 is moved a specific distance downward. Exactly as in the illustration in FIGS. 12-14, an intermediate body is also applied here, after application of first filling 3.2, comprising a material which may evaporate under specific conditions, as well as a second filling, which represents the second support body half. This state is shown in phase III. Piston 21, still moved downward, is shown here, but now carrying the first filling, the intermediate body, and the second filling. The two fillings blend into one another, so that there is no mold seam. The two fillings have now become one single molded part, which encloses intermediate body 3.7.

Phase IV shows piston 21, which is still in the position of phase III, as well as the molded part described having the intermediate body. A second piston 22 may also be seen here, which is now lowered from above onto the molded part. The molded part is now compressed between both pistons 21, 22, at least one of the two pistons being moved relative to the other one. If piston 22 is moved, it runs in the same cylindrical sleeve 20 as piston 21.

Simultaneously with the application of pressure, heat may also be applied to the molded part.

In phase V, both pistons 21, 22 are raised upward. Piston 22 is raised up in this case in such a way that it no longer touches the molded part. The molded part is now located with its lower edge at the height of the upper edge of cylindrical sleeve 20. It may be displaced in the direction of the arrow and thus removed from piston 21.

A sintering process follows phase V. In this case, the molded part is subjected to high temperatures. The support body, which is now solid, results. Intermediate body 3.7 is made of a material which, under the effect of appropriate temperatures and/or chemicals, either evaporates or dissolves, so that corresponding cavities remain in the support body, in order to be used as channels in the finished, plate-shaped filtration body.

The intermediate body material is also expediently non-compressible.

Instead of the membrane filter layer described in the description of the figures, another filtering layer may also be used. It may be constituted as follows: It may be a membrane, which is made of ceramic or polymer or metal. However, it may also be a screen or a nonwoven. This may be made of metal or polymer.

The hollow shaft having the filtration plates may perform a rotational movement around its longitudinal axis.

What is claimed is:

1. A method for producing a plate-shaped filtration body (filtration plate), comprising:
two support body halves, tightly bonded to one another, which are made of a porous material and enclose permeate diversion channels between them;
at least one filtering layer, which is applied to the outsides of the support body halves, having the following method steps:
1.1 the two support body halves (3.2, 3.3) are produced through casting in a type of slip casting;
1.2 the casting mold (10) is made of porous, possibly hydrophilic material;
1.3 the mold cavity is dimensioned in such a way that its inner contour approximately corresponds to the outer contour of the support body (3.2, 3.3);
1.4 to produce the two bonded support body halves (3.2, 3.3), a first quantity of suspended support body material, which corresponds to the support body half (3.2), is poured into the mold (10.1);
1.5 an intermediate body (3.7), which functions as a casting core and is made of a material which evaporates under the influence of heat and has openings, is applied to the first quantity of suspended support body material;
1.6 a second quantity of suspended support body material, which corresponds to the second support body half (3.3), is poured into the mold (10.1);
1.7 the surface of this second pour is possibly brought into contact with a cover (10.2) of the mold (10);
1.8 the entire molded part—comprising the two support body halves (3.2, 3.3) bonded to one another and the intermediate body (3.7)—is removed from the mold (10), sintered, and possibly processed;
1.9 at least one filtering layer (3.5) is applied to the outsides of the molded part.

2. The method according to claim 1,
characterized in that two or more filtering layers are applied to the outsides of the molded part.

3. A method for producing a plate-shaped filtration body (filtration plate), comprising:
two support body halves, tightly bonded to one another, which are made of a porous material and enclose permeate diversion channels between them;
at least one filtering layer, which is applied to the outsides of the support body halves, having the following method steps:
3.1 a first quantity of sinterable powder is shaken into a mold cavity, whose inner contour approximately corresponds to the outer contour of the support body;
3.2 an intermediate body, which is made of a material which evaporates under pressure and/or heat, is applied to the filling;
3.3 a second quantity of sinterable powder is shaken onto the intermediate body;
3.4 the two fillings, with the intermediate body located between them, are molded into an intermediate product through compression;
3.5 the intermediate product is sintered and possibly brought into the final shape through mechanical processing.

4. The method according to claim 3,
characterized in that the sinterable powder is a ceramic powder or a metal powder or a plastic powder.

5. The method according to claim 3 or 4,
characterized in that the two fillings, with the intermediate body located between them, are first subjected to compression and then to sintering.

6. The method according to one of claims 3 or 4,
characterized in that the intermediate product is mechanically processed after removal from the mold cavity and/or after sintering.

7. The method according to one of claims 3 to 6,
characterized in that the boundary surfaces of the mold cavity are the faces (21.1, 22.1) of pistons (21, 22).

8. The method according to claim 7,
characterized in that the faces (21.1, 22.1) of the pistons (21, 22) are flat or convex or concave.

9. A method for producing a plate-shaped filtration body (filtration plate), comprising two support body halves (3.2, 3.3), which are tightly bonded to one another, having the following method steps:
9.1 a divided casting mold (10) is provided, comprising two casting mold parts (10.1, 10.2), which form a mold cavity with one another, whose inner contour approximately corresponds to the outer contour of the support body (3.2, 3.3);
9.2 an intermediate body (3.7) is introduced into the mold cavity, which functions as a casting core and is made of a material which evaporates under the influence of heat and has openings;
9.3 an appropriate quantity of suspended support body material is injected into the mold cavity, so that it encloses the intermediate body (3.7) on all sides;
9.4 an open-pore material is used as the material for the mold (10);
9.5 the suspension is dehydrated through the pores of the material of the mold (10) by applying pressure or partial vacuum;
9.6 after the dehydration, the entire molded part—comprising the two support body halves (3.2, 3.3) and the intermediate body (3.7)—is removed from the mold, sintered, possibly processed, and provided with at least one filtering layer.

10. A method for producing a plate-shaped filtration body (filtration plate), comprising two support body halves (3.2, 3.3), which are tightly bonded to one another, having the following method steps:
10.1 a divided casting mold (10) is provided, comprising two casting mold parts (10.1, 10.2), which form a mold cavity with one another, whose inner contour approximately corresponds to the outer contour of the support body (3.2, 3.3);
10.2 an intermediate body (3.7) is introduced into the mold cavity, which functions as a casting core and is made of a material which evaporates under the influence of heat and has openings;
10.3 an appropriate quantity of suspended support body material is injected into the mold cavity, so that it encloses the intermediate body (3.7) on all sides;
10.4 the suspension has a binder, which induces polymerization;
10.5 the polymerization is performed;
10.6 the molded body is—before or after removal from the mold (10)—possibly processed, sintered, possibly reprocessed, and provided with at least one filtering layer on the outsides of the support body halves.

11. The method according to one of claims 1 to 10,
characterized in that the mold cavity is plate shaped.

12. The method according to one of claims 1 to 11,
characterized in that the filtering layer is a membrane, made of ceramic or polymer or metal, for example, or a screen and/or nonwoven made of metal or polymer.

13. A plate-shaped filtration body (filtration plate),
characterized in that it is produced and constructed according to a method according to one of claims 1 to 12.

14. The plate-shaped filtration body (filtration plate) according to claim 13;
14.1 having a plate made of a coarse-pored support body material made of ceramic or metal or plastic with a central hole;
14.2 having at least one filtering layer, which covers at least a part of the outside of the plate;
14.3 having channels which are positioned in the inside of the plate and produce a conductive connection between the peripheral region of the plate and the central hole;
14.4 the plate is of homogeneous, monolithic structure having uniform strength and is free of interfaces.

15. The plate-shaped filtration body according to claim 13 or 14,
characterized in that the outside is reinforced at especially stressed points, for example by applying additional coatings, compression of the membrane, or separate treatment using laser beams.

16. The plate-shaped filtration body according to one of claims 13 to 15,
characterized in that the filtering layer is a membrane, made of ceramic or polymer or metal, for example, or a screen and/or nonwoven made of metal or polymer.
